(19) United States
(12) Patent Application Publication
(10) Pub. No.: US 2023/0057714 A1
(43) Pub. Date: Feb. 23, 2023

(54) FRICTION HEAD AND FRICTION ADDITIVE MANUFACTURING METHOD OF ADJUSTING COMPONENTS AND SYNCHRONOUSLY FEEDING MATERIAL

(71) Applicant: Harbin Institute of Technology, Harbin (CN)

(72) Inventors: Yongxian Huang, Harbin (CN); Xiangchen Meng, Harbin (CN); Mingda Zou, Harbin (CN); Yuming Xie, Harbin (CN)

(73) Assignee: Harbin Institute of Technology, Harbin (CN)

(21) Appl. No.: 17/406,571

(22) Filed: Aug. 19, 2021

(51) Int. Cl. B23K 20/12; B33Y 10/00; B33Y 30/00

(52) U.S. Cl. CPC B23K 20/1215; B33Y 10/00; B33Y 30/00

(57) ABSTRACT

A friction head and a friction additive manufacturing method of adjusting components and synchronously feeding material are provided. The friction head includes a friction body, a charging part and a feeding part. An axis of the friction body, an axis of the charging part and an axis of the feeding part are coincided with one another. The charging part and the feeding part are sleeved on the friction body. Spiral groove(s) extending in a same direction is formed in an inner ring wall of the feeding part. The spiral groove(s) extends through the inner ring wall of the feeding part and is symmetrical about the axis of the feeding part. The spiral groove(s) and a lower outer surface of the feeding part form spiral feeding channel(s). An upper end of each feeding channel is communicated with a corresponding one of feeding hole(s).

### TECHNICAL FIELD

The present disclosure relates to a friction head and a friction additive manufacturing method of adjusting components and synchronously feeding material, and in particular, to a friction head for synchronously and continuously feeding and a friction additive manufacturing method carried out by the friction head, which belongs to the field of friction additive manufacturing technologies.

### BACKGROUND ART

Additive manufacturing is a technology that a thin layer of a desired shape and size is created by controlling two-dimensional data of the thin layer based on a discrete-deposition principle, and then the solid-state model is formed by adding material layer by layer. The part with a complicated shape can be manufactured rapidly and precisely by additive manufacturing in a manner of adding material, based on image data generated by a computer and a robot integrated system. Thus, the free fabrication in the true sense can be realized.

Existing additive manufacturing methods are mostly based on the selective deposited sintering manufacturing methods. Specifically, the metal in a selected area is melted and sintered by one or more heat sources, and then deposited to form a desired part. This process is essentially realized by performing micro-casting several times, so, the product may have the defects of complex internal stress, non-uniform microstructure, coarse grain, small grain size number, etc. In the formation fields of aluminum alloy, magnesium alloy, copper alloy, carbon steel, and alloy steel that are commonly used, there is a significant difference between the mechanical properties of a workpiece manufactured by the selective deposited sintering and the mechanical properties of a workpiece made by a conventional manufacturing method using the same material. Therefore, it is necessary to provide a friction head and a friction additive manufacturing method of adjusting components and synchronously feeding material, so as to solve the problems of the existing additive manufacturing techniques, e.g., easy formation of pores, reduction in mechanical strength, etc.

### SUMMARY

To solve the problems of easy formation of pores, reduction in mechanical strength in the existing additive manufacturing techniques, there provides a friction additive manufacturing method and a friction head which can synchronously and continuously feed material, continuously perform the additive manufacturing, achieve the direct formation that is from solid phase to solid phase and achieve the deformation strengthening.

The following technical solution of the present disclosure is provided.

A friction head comprising a friction body, a charging part and a feeding part, wherein the charging part and the feeding part are arranged from up to down in sequence and integrally formed; an axis of the friction body, an axis of the charging part and an axis of the feeding part are coincided with one another; and the charging part and the feeding part are sleeved on the friction body; the friction body comprises a grip portion, a connection portion and a friction portion that are arranged from up to down in sequence and integrally formed; the grip portion is a cylinder and an outer surface thereof has a grip surface; the friction portion is a cylinder, and one end of the friction portion is fixedly connected to the connection portion, and another end of the friction portion is an inner concave surface; and the charging part and the feeding part are sleeved on the friction portion; the charging part is cylindrical and a circular through hole is formed in a center of a bottom thereof; the friction body is arranged in the charging part through the circular through hole; a periphery of the circular through hole is located on an upper outer surface of the feeding part; an inner wall of the charging part and an upper surface of the feeding part form an annular upper storage bin together with an outer surface of the friction portion; and at least one feeding hole which is symmetrical about the axis of the charging part are formed in the bottom of the charging part; and the feeding part is of a ring-shaped structure; at least one spiral groove extending in a same direction is formed in an inner ring wall of the feeding part; the at least one spiral groove extends through the inner ring wall of the feeding part and is symmetrical about the axis of the feeding part; the feeding part is sleeved in a lower portion of the friction portion; the at least one spiral groove and a lower outer surface of the feeding part form at least one spiral feeding channel; and an upper end of each of the at least one feeding channel is communicated with a corresponding one of the at least one feeding hole.

Preferably, the inner concave surface of the friction portion is a circular conical surface with an angle of 3°-5°.

Preferably, each of the at least one feeding channel has a rectangular cross section with a screw pitch of 12 mm and an outer diameter of 24-100 mm.

Preferably, each of the at least one feeding hole has a diameter of 4-12 mm.

Preferably, the at least one feeding hole includes a plurality of feeding holes not symmetrical about the axis of the friction body; or the at least one feeding channel includes a plurality of feeding channels not symmetrical about the axis of the friction body.

Preferably, the friction body is made of H13 hot-work die steel, high speed steel or ceramics.

A friction additive manufacturing method of adjusting components and synchronously feeding material carried out by the friction head as described above includes the following steps.

In step 1, polishing a surface of a substrate using acetone, mounting the grip portion of the friction body on a rotating shaft of a friction stir welding machine by the grip surface, and enabling the inner concave surface of the friction portion to be in contact with the surface of the substrate; in step 2, adjustment of a tilt angle of the friction head: adjusting a range of an included angle between the axis of the friction head and a normal line of the substrate to 0-3°; in step 3, transferring the friction head to the surface of the substrate and pressing the friction head into the surface of the substrate, wherein a press depth is 0.05-1 mm; adding formation powder to the upper storage bin of the charging part in the friction head; in step 4, starting the friction stir welding machine, performing additive manufacturing in a manner of the friction head rotating at a velocity of 10-5000 rpm and advancing at a speed of 1-200 mm/min; and obtaining an additive layer; and in step 5, repeating steps 1 to 4, removing the formation powder in the friction head after performing the additive manufacturing repeatedly, and then rolling the additive layer on the substrate by the friction head.

Preferably, in step 1, a type of the formation powder is one or more, the formation powder comprises a metal powder or a powder mixture of the metal powder and a reinforcement phase, and the reinforcement phase is carbon material, ceramics, metal oxide or/and silicon carbide.

The friction head and a friction additive manufacturing method of adjusting components and synchronously feeding material provided in embodiments have the advantages as follows. Firstly, compared with conventional additive manufacturing methods that is from solid phase to liquid phase and then to solid phase, in the method of the present embodiment, the formation material may be molded from the formation powder of the solid phase to additive layers of the solid phase without melting and solidification, thereby preventing the defects of cracks, pores, etc. Secondly, the method of the present embodiment is not limited by the equilibrium metallurgy to a certain extent, thereby realizing a larger regulation range of components, which has the potential to prepare the high-performance functional material. This method can be used to prepare the novel composite material due to the low requirement on the compatibility of components of the composite material. For example, the novel aluminum-matrix composite may be prepared by carbon nanotubes as a reinforcement phase. Moreover, in this method, novel alloys that are hard to be prepared or cannot be prepared in an equilibrium metallurgic process may be prepared, because no molten metal is generated during manufacturing and the precipitation of a component does not occur in the melting metallurgy after the completion of manufacturing. For example, an aluminum-copper alloy having more than 20% (by mass) of copper may be prepared. Furthermore, in this method, the formation temperature is low, the physical and chemical properties of each component in the composite material is difficult to be impaired, so, this method can be used to prepare the high-performance material or ensure that the functional units in the functional material are not damaged during forming. For example, platinum-carbon-catalyst additive layers formed on an aluminum plate by this method may still have a higher activity. Finally, the friction head may realize the continuous and synchronous solid-phase additive manufacturing. In addition, during the additive manufacturing, it is possible to synchronously change the formation parameters, a ratio of the additive powder and the like related to the physical and chemical properties of the additive area, and a mixing ratio of components and the like related to the selective control.

### BRIEF DESCRIPTION OF THE DRAWINGS

FIG. 1 is a sectional view of a friction head according to an embodiment of the present disclosure.

FIG. 2 is a perspective structural diagram of a friction head according to an embodiment of the present disclosure.

FIG. 3 is a top view of a friction head according to an embodiment of the present disclosure.

FIG. 4 is a schematic structural diagram of a friction head when operating according to an embodiment of the present disclosure.

List of reference numerals: 1, friction body; 2, charging part; 3, feeding part; 4, substrate; 5, additive layer; 1-1, grip portion; 1-2, connection portion; 1-3, friction portion; 2-1, upper storage bin; 2-2, feeding hole; 3-1, feeding channel; and 1-1-1, grip surface.

### DETAILED DESCRIPTION OF THE PREFERRED EMBODIMENTS

### Example 1

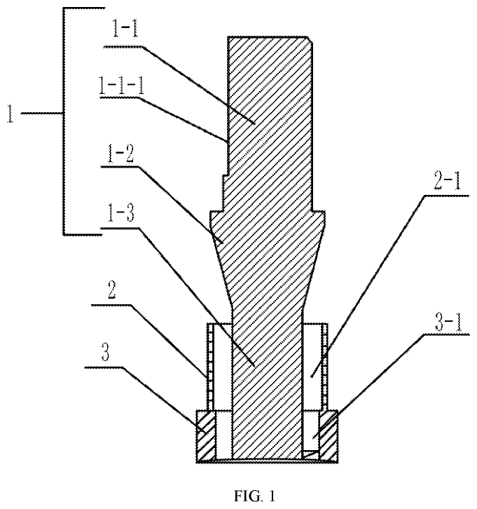

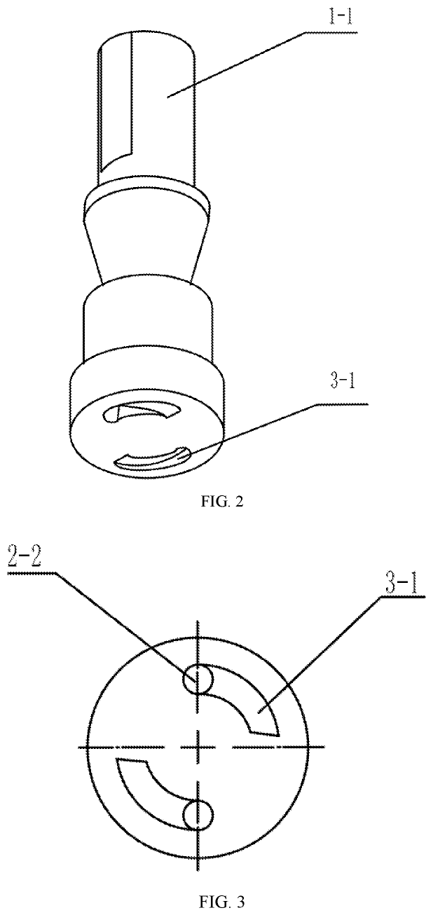

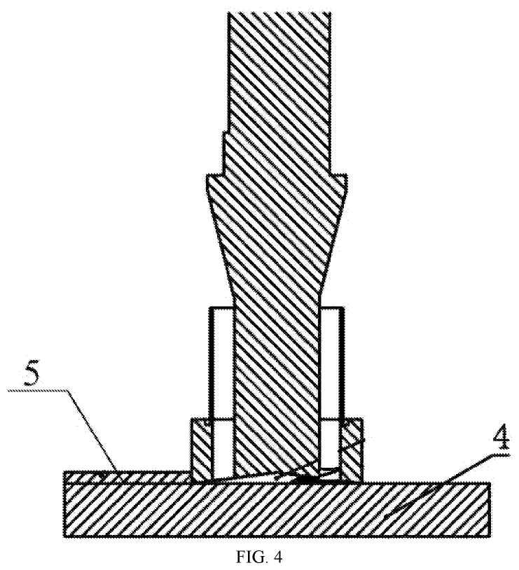

The specific examples of the present disclosure are described below with reference to FIG. 1 to FIG. 4. The present disclosure relates to a friction head and a friction additive manufacturing method of adjusting components and synchronously feeding material. The friction head includes a friction body 1, a charging part 2 and a feeding part 3. The charging part 2 and the feeding part 3 are arranged from up to down in sequence and integrally formed. Axes of the friction body 1, the charging part 2 and the feeding part 3 are coincided with one another. The charging part 2 and the feeding part 3 are sleeved on the friction body 1.

The friction body 1 includes a grip portion 1-1, a connection portion 1-2 and a friction portion 1-3 that are arranged from up to down in sequence and integrally formed. The grip portion 1-1 is a cylinder and an outer surface thereof has a grip surface 1-1-1. The friction portion 1-3 is a cylinder. One end of the friction portion 1-3 is fixedly connected to the connection portion 1-2, and the other end of the friction portion 1-3 is an inner concave surface. The charging part 2 and the feeding part 3 are sleeved on the friction portion 1-3.

The charging part 2 is cylindrical, and a circular through hole is formed in a center of a bottom thereof. The friction body 1 is arranged in the charging part 2 through the circular through hole. A periphery of the circular through hole is located on an upper surface of the feeding part 3. An inner wall of the charging part 2 and the upper surface of the feeding part 3 form an annular upper storage bin 2-1 together with an outer surface of the friction portion 1-3. Moreover, two feeding holes 2-2 which are symmetrical about the axis of the charging part 2 are also formed in the bottom of the charging part 2.

The feeding part 3 is a ring-shaped structure. Two spiral grooves extending in a same direction are formed in an inner ring wall of the feeding part. The two spiral grooves extend through the inner ring wall of the feeding part and are symmetrical about the axis of the feeding part 3. The feeding part 3 is sleeved in a lower portion of the friction portion 1-3. The two spiral grooves and a lower outer surface of the feeding part 3 form two spiral feeding channels 3-1. Upper ends of the feeding channels 3-1 are communicated with the respective feeding holes 2-2. As such, the grip portion 1-1 of the friction body 1 is mounted on a friction stir welding machine by means of the grip surface 1-1-1, and the inner concave surface of the friction portion 1-3 is pressed into the surface of a substrate 4 for the continuous additive manufacturing, so as to form an additive layer 5 on the upper surface of the substrate 4, based on the additive solid-phase formation. The upper storage bin 2-1 is an open storage bin, and the formation powder having different components can be added to the upper storage bin 2-1 before or during the additive manufacturing. During the additive manufacturing, the formation powder having different components in the upper storage bin 2-1 is synchronously fed into the feeding channels 3-1 via the feeding holes 2-2; then entered into a cavity formed by the inner concave surface of the friction portion 1-3 and the substrate 4 through the feeding channels 3-1; and formed additive layer 5 continuously under the action of the rotation and the squeezing of the inner concave surface. In this way, the additive layer 5 is solidified on the substrate, thereby heightening the forming surface. After the additive layer 5 may reach a particular height by performing the additive manufacturing many times, the formation powder in the friction head may be removed, and then the additive layers may be rolled by using the friction head. So, the tensile stress of the surface layer of the additive layers is transformed into the pressing stress, thereby improving the corrosion resistance of the additive layers. In addition, the feeding channels 3-1 are of a spiral structure, and the inner wall thereof having a particular tilt angle exerts the pressing force on the formation powder in the inner concave surface by means of the rotation torque during rotation, thereby preventing the formation powder in the inner concave surface from flowing back to the feeding channels 3-1.

The inner concave surface of the friction portion 1-3 is a circular conical surface with an angle of 3°-5°. The angle of 3°-5° is an intersection angle between an inclined surface of the inner concave surface and a bottom surface of the feeding part 3. As such, the inner concave surface of the friction portion 1-3 is the circular conical surface with the angle of 3°-5°, so that a cavity is formed between the friction portion 1-3 and the substrate 4 after the friction portion 1-3 is pressed into the surface of the substrate 4. The additive layer 5 is formed continuously by the formation powder in the cavity under the action of the rotation of the friction head. Besides, the inner concave surface may be added with textures to enhance the fluidity of material.

Each feeding channel 3-1 has a rectangular cross section with a screw pitch of 12 mm and an outer diameter of 24-100 mm. As such, each feeding channel 3-1 is spiral, and the inner wall thereof having a particular tilt angle exerts the pressing force on the formation powder in the inner concave surface by means of the rotation torque during rotation, thereby preventing the formation powder in the inner concave surface from flowing back to the feeding channels 3-1.

Each feeding hole 2-2 has a diameter of 4-12 mm. As such, the formation powder having different components in the upper storage bin 2-1 may be fed to the feeding channels 3-1 through the feeding holes 2-2.

Preferably, there may be at least one feeding hole 2-2, and at least one feeding channel 3-1. There may be a plurality of feeding holes 2-2 or a plurality of feeding channels 3-1 not necessarily symmetrical about the axis of the friction body 1.

The friction body 1 is made of H13 hot-work die steel, high speed steel or ceramics.

A friction additive manufacturing method of adjusting components and synchronously feeding material carried out by the friction head includes the following steps.

In step 1, a surface of a substrate 4 is polished using acetone, the grip portion 1-1 of the friction body 1 is mounted on a rotating shaft of a friction stir welding machine by the grip surface 1-1-1, and the inner concave surface of the friction portion 1-3 is enabled to be in contact with the surface of the substrate 4. In step 2, adjustment of a tilt angle of the friction head: a range of an included angle between the axis of the friction head and a normal line of the substrate 4 is adjusted to 0-3°.

In step 3, the friction head is transferred to the surface of the substrate 4 and the friction head is pressed into the surface of the substrate 4, where a press depth is 0.05-1 mm; and formation powder is added to the upper storage bin 2-1 of the charging part 2 in the friction head.

In step 4, the friction stir welding machine is started, additive manufacturing is performed in a manner of the friction head rotating at a speed of 10-5000 rpm and advancing at a speed of 1-200 mm/min; and an additive layer 5 is obtained.

In step 5, steps 1 to 4 are repeated, the formation powder in the friction head is removed after performing the additive manufacturing repeatedly, and then a formed additive layer 5 on the substrate 4 is rolled by using the friction head. As such, heat and deformation generated by the friction of the friction head can cause the formation powder to be solidified on the substrate 4, so as to form the additive layer 5. In the friction additive manufacturing method, the formation material may be molded from the formation powder of the solid phase to additive layers of the solid phase without melting and solidification, thereby preventing the defects of cracks, pores and the like in terms of the principle. Furthermore, the method is not limited by the equilibrium metallurgy to a certain extent, thereby realizing a larger regulation range of components, which has the potential to prepare the high-performance functional material. This method can be used to reinforce the additive layers by generating the intensification and dislocations of a large number of fine grains by the friction and the forging. For example, the novel aluminum-matrix composite material may be prepared by using carbon nanotubes as reinforcement phase. Furthermore, in this method, the formation temperature is low, so it is ensure that the functional units in the functional material are not damaged during formation. For example, platinum-carbon-catalyst additive layers formed on an aluminum plate by this method may still have a higher activity. In this method, solid phase metallurgical formation of a composite material may be realized. For example, carbon-nanotube-reinforced aluminum matrix composite material may be prepared by adjusting a mass ratio of the carbon nanotube to aluminum powder and adding the carbon nanotubes (0-10%) as the reinforcement phase to the aluminum powder.

Additionally, a type of the formation powder is one or more in step 1. The formation powder includes metal powders or powder mixtures of the metal powders and reinforcement phases. The reinforcement phase is carbon material, ceramics, a metal oxide or/and silicon carbide. As such, a powder mixture with different components can be added synchronously during the additive manufacturing. For example, an aluminum-copper alloy with copper of the high ratio may be prepared by adjusting a mass percentage of copper powder in an aluminum-copper powder mixture to a range of 0-20%.

This embodiment is merely illustrative of the present disclosure and not intended to limit the protection scope thereof. A person skilled in the art can make changes to part of this embodiment, and any change made without departing from the spirit of the present disclosure shall be encompassed within the protection scope of the present disclosure.

What is claimed is:

1. A friction head comprising a friction body, a charging part and a feeding part, wherein the charging part and the feeding part are arranged from up to down in sequence and integrally formed; an axis of the friction body, an axis of the charging part and an axis of the feeding part are coincided with one another; and the charging part and the feeding part are sleeved on the friction body;
the friction body comprises a grip portion, a connection portion and a friction portion that are arranged from up to down in sequence and integrally formed; the grip portion is a cylinder and an outer surface thereof has a grip surface; the friction portion is a cylinder, and one end of the friction portion is fixedly connected to the connection portion, and an other end of the friction portion is an inner concave surface; and the charging part and the feeding part are sleeved on the friction portion;
the charging part is cylindrical and a circular through hole is formed in a center of a bottom surface thereof; the friction body is arranged in the charging part through the circular through hole; a periphery of the circular through hole is located on an upper surface of the feeding part; an inner wall of the charging part and the upper surface of the feeding part form an annular upper storage bin together with an outer surface of the friction portion; and at least one feeding hole which is symmetrical about the axis of the charging part are formed in the bottom of the charging part; and
the feeding part is of a ring-shaped structure; at least one spiral groove extending in a same direction is formed in an inner ring wall of the feeding part; the at least one spiral groove extends through the inner ring wall of the feeding part and is symmetrical about the axis of the feeding part; the feeding part is sleeved in a lower portion of the friction portion; the at least one spiral groove and a lower outer surface of the feeding part form at least one spiral feeding channel; and an upper end of each of the at least one feeding channel is communicated with a corresponding one of the at least one feeding hole.

2. The friction head according to claim 1, wherein the inner concave surface of the friction portion is a circular conical surface with an angle of 3°-5°.

3. The friction head according to claim 1, wherein each of the at least one feeding channel has a rectangular cross section with a screw pitch of 12 mm and an outer diameter of 24-100 mm.

4. The friction head according to claim 1, wherein each of the at least one feeding hole has a diameter of 4-12 mm.

5. The friction head according to claim 1, wherein the at least one feeding hole comprises a plurality of feeding holes not symmetrical about the axis of the friction body; or the at least one feeding channel comprises a plurality of feeding channels not symmetrical about the axis of the friction body.

6. The friction head according to claim 1, wherein the friction body is made of H13 hot-work die steel, high speed steel or ceramics.

7. A friction additive manufacturing method of adjusting components and synchronously feeding material, the friction additive manufacturing method being carried out by the friction head according to claim 1, wherein the friction additive manufacturing method comprises:
step 1, polishing a surface of a substrate using acetone, mounting the grip portion of the friction body on a rotating shaft of a friction stir welding machine by the grip surface, and enabling the inner concave surface of the friction portion to be in contact with the surface of the substrate;
step 2, adjustment of a tilt angle of the friction head: adjusting a range of an included angle between the axis of the friction head and a normal line of the substrate to 0-3°;
step 3, transferring the friction head to the surface of the substrate and pressing the friction head into the surface of the substrate, wherein a press depth is 0.05-1 mm; and adding formation powder to the upper storage bin of the charging part in the friction head;
step 4, starting the friction stir welding machine, performing additive manufacturing in a manner of the friction head rotating at a speed of 10-5000 rpm and advancing at a speed of 1-200 mm/min; and obtaining an additive layer; and
step 5, repeating steps 1 to 4, removing the formation powder in the friction head after performing the additive manufacturing repeatedly, and then rolling a formed additive layer on the substrate by using the friction head.

8. The friction additive manufacturing method of adjusting components and synchronously feeding material according to claim 7, wherein in step 1, a type of the formation powder is one or more, the formation powder comprises a metal powder or a powder mixture of the metal powder and a reinforcement phase, and the reinforcement phase is carbon material, ceramics, metal oxide or/and silicon carbide.
